(19) United States
(12) Patent Application Publication
(10) Pub. No.: US 2006/0076344 A1
(43) Pub. Date: Apr. 13, 2006

(54) Self temperature control protection heater

(75) Inventors: Shuenn-Tian Chien, Nan Tou City (TW); Wen-Jun Lu, Taichung City (TW); Chu-Kuo Gee, Taichung Hsien (TW)

Correspondence Address: LEONG C LEI, PMB # 1008, 1867 YGNACIO VALLEY ROAD, WALNUT CREEK, CA, 94598, US

(73) Assignee: Mobiletron Electronics Co., Ltd.

(21) Appl. No.: 10/962,393

(22) Filed: Oct. 13, 2004

(51) Int. Cl. H05B 3/10

(52) U.S. Cl. 219/548

(57) ABSTRACT

A heater with self-temperature control protection comprised of a thick film metalized substrate, a signal touch switch, a level detection circuit, a control circuit, a signal amplification circuit and a temperature setup circuit to deliver electricity from the signal touch control respectively to both inputs of the control circuit to output to the signal touch switch for providing instantaneous self-protection at a given temperature with greater energy, smaller area, and higher efficiency than that of the conventional heater.

### BACKGROUND OF THE INVENTION

(a) Technical Field of the Invention

The present invention is related to a self-temperature control protection heater, and more particularly, to an innovative heating element adapted to a temperature controller for providing instantaeous self-protection of massive energy, small area, and high efficient at a specific temperature.

(b) Description of the Prior Art

Thermal energy, discovered by our ancestors, ranging from fire for cooking or fending off bitter cold winters and wild animals to natural sources, including terrestrial heat and sun light for keeping the globe warm enough for all creatures, is a must. However, neither fails to satisfy modern life. Upgraded capabilities to control energy technology help introduce various types of heaters allowing an easier and immediate access to thermal energy at a rated setting. The most popular heater relates to one that converts electricity into heat and the heater has become vital and necessary either in military, industry or consumer applications. However, the heater consumes an extremely high portion of energy. How to develop a heating element with high efficiency at a cheap cost is a common goal sought by the trade concerned.

Among all those heaters generally available in the market, the heating wire (NiCr wire) dominates in terms of AC powered heaters. As illustrated in FIG. 1 of the accompanying drawings for an exploded view of an electric fire, a heating wire 10 is used. A metal heating member 30 must be provided over the heating wire 10. The heated heating wire 10 heats up the heating member 30 through a space 20 in the peripheral of the heating wire 10 for the metal heating member 30 to heat up an object by contract placed on the metal heating member 30. The electric fire though offering cheap production cost is observed with the following flaws:
1. Low heating efficiency: heat is transmitted either by transfer, convection, or radiation at a sequence of transmission speed. As the heating wire for being conducted prevents direct contact of the object to be heated, the heat is transmitted essentially by radiation aided by convection. Wherein, heat convection takes place between the air in the space surrounding the heating wire and the metal heating member before reaching the metal heating member by radiation. Consequently, direct heat transmission route to the object to be heated is impossible, meaning lots of thermal energy will be rendered useless. Furthermore, the low heat transmission rate attributes to great fall of temperature between the heating wire and the object to be heated, the diameter of the heating wire is prevented from being enlarged without restriction for the concern that it may be burnt out. Saving the concern, thicker heating wire contributes longer heating time; more thermal energy wasted; and lower heating efficiency. The option of winding the heating wire around an insulator (mica sheet) and another mica sheet is further attached to the object to be heated though constitutes a close stacked contact to prevent leakage and comply with heat transmission requirements, easy heat transmission is prevented due to that the mica sheet is not a goof heat conductor.
2. Low safety: as the heating wire gets red hot at higher temperatures to become a source vulnerable to causing fire hazards while consuming the oxygen in the air to continuously create traces of gas combustion pollution. When an electric cooking spoon is put into a pot containing water, traces of the metal coating of the heating tube will be dissolved into the boiling water to present health hazard to the user.

### SUMMARY OF THE INVENTION

The primary purpose of the present invention is to provide a heater with self-temperature control protection that directly transmits thermal energy to the object to be heated in a heating efficiency much higher than the conventional heater. To achieve the purpose, the method of thick film metalized substrate is used. A flat (Ceramic Al₂O3) substrate is sintered with thick film for conductor to serve as conduction wire; and a conductor paste or low ohm paste printed resistance (Rx), as the hot air generator. The ceramic substrate, being a good heat conductor, serves as an insulator, and also a heat transfer medium to directly contact the objected to be heated by instantaneously supplying high wattage (up to 100 W for the dimension of the preferred embodiment as illustrated in FIG. 2). Whereas the paste is sintered at 850° C., it is capable of withstanding heat up to 500° C. without deterioration in directly transferring the thermal energy to the object to be heated at a thermal efficiency higher than that of the prior art.

Another purpose of the present invention is to provide a heater with self-temperature control protection that achieves the dual purposes of self-protection and thermostat control. To achieve the purposes, the low resistance thick film paste, particularly, the conductor paste resistance has a high temperature coefficient resistance (TCR) to permit the optimal flexibility in temperature regulation to compromise the changes in temperature. Furthermore, a temperature sensor in the temperature controller is provided on the same substrate, and the control circuit precisely controls the temperature of the substrate not to exceed the preset upper limit of temperature. Accordingly, the heater is capable of providing higher wattage to secure self-protection before the temperature of the substrate increases to its preset upper limit; and the thermal electricity is conducted only after the heat transferred from the substrate to the object to be heated drops. Whereas the substrate maintains at a constant temperature to feed back a signal for joint control of the conduction of thermal electricity when the temperature of the object to be heated drops to a degree as desired for instantaneously providing high wattage.

Another purpose yet of the present invention is to provide a heater with self-temperature control protection that allows wider voltage withstanding range for the entire control circuit by permitting the protection setup at 500° C. or below with the omission of any transformer to protect the control circuit from burning out by high voltage and/or high temperature. To achieve the purpose, a complete thermal temperature control system is comprised of a filter connected in series with a bridge type of rectifier for an AC source circuit, a signal contact switch for control conduction of a heater (i.e. the ceramic transmission hot air generator to be described later), a ceramic heater (the substrate printed with heater Rx+temperature sensing resistance Rs), a signal amplifier, a temperature setup circuit, a level detection circuit, and a control circuit.

Another purpose yet of the present invention is to provide a heater with self-temperature control protection that is safe to use without fear of getting electric shock from the object to be heated. To achieve the purpose, the present invention is made of ceramic material that is an insulator while offering the functions of heat transfer and withsanding.

The foregoing object and summary provide only a brief introduction to the present invention. To fully appreciate these and other objects of the present invention as well as the invention itself, all of which will become apparent to those skilled in the art, the following detailed description of the invention and the claims should be read in conjunction with the accompanying drawings. Throughout the specification and drawings identical reference numerals refer to identical or similar parts.

Many other advantages and features of the present invention will become manifest to those versed in the art upon making reference to the detailed description and the accompanying sheets of drawings in which a preferred structural embodiment incorporating the principles of the present invention is shown by way of illustrative example.

### BRIEF DESCRIPTION OF THE DRAWINGS

FIG. 1 is an exploded view of an electric fire adapted with a heating wire heater of the prior art.

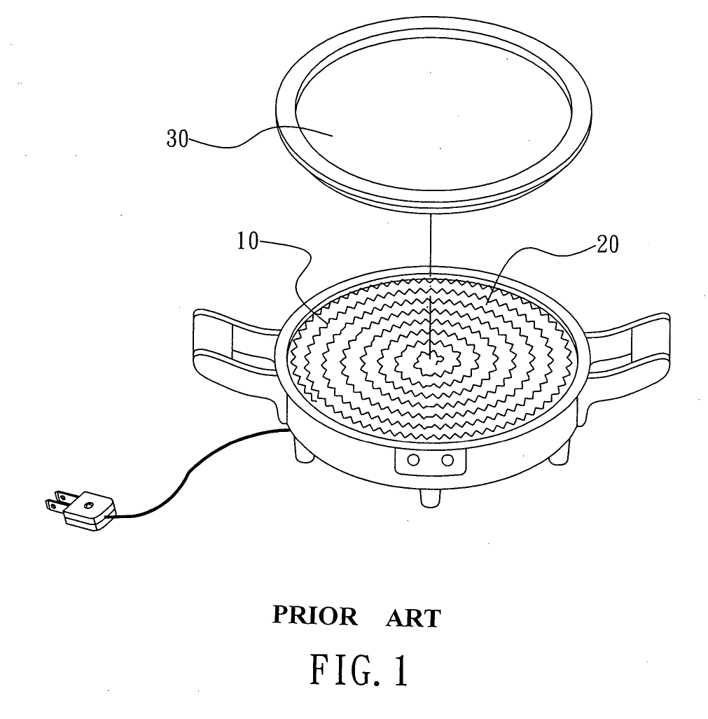

FIG. 2 is a schematic view showing a flat ceramic substrate of the present invention.

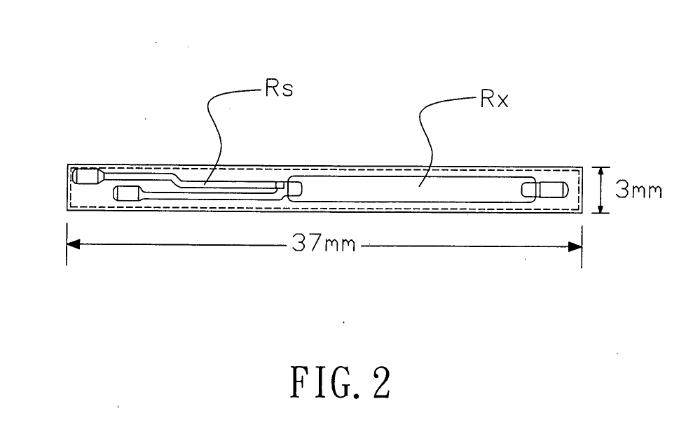

FIG. 3 is a circuit diagram of a preferred embodiment of the present invention.

FIG. 4 is a circuit diagram of another preferred embodiment of the present invention.

### DETAILED DESCRIPTION OF THE PREFERRED EMBODIMENT

The following descriptions are of exemplary embodiments only, and are not intended to limit the scope, applicability or configuration of the invention in any way. Rather, the following description provides a convenient illustration for implementing exemplary embodiments of the invention. Various changes to the described embodiments may be made in the function and arrangement of the elements described without departing from the scope of the invention as set forth in the appended claims.

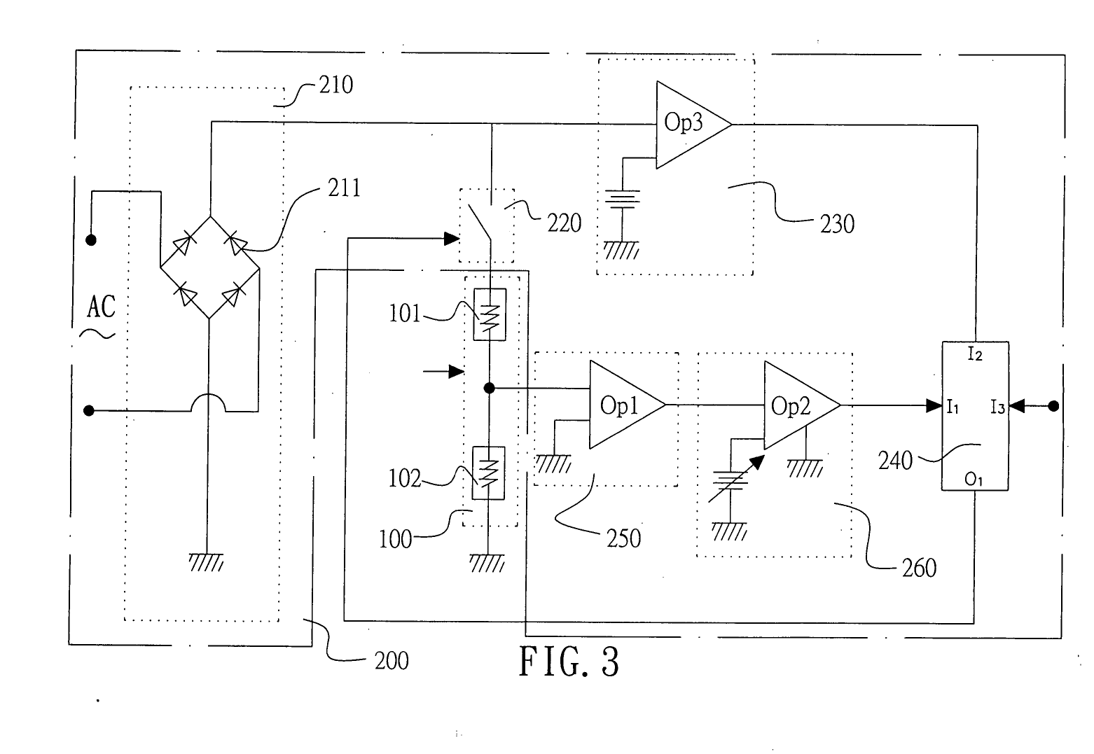

Referring to FIG. 3, the present invention is essentially comprised of a thick film metalized substrate 100, a source circuit 210, a signal touch switch 220, a level detection circuit 230, a control circuit 240, a signal amplification circuit 250 and a temperature setup circuit 260. Wherein, the control circuit 240 relates to a single chip with matching functions. The source circuit relates to a bridge rectifier 211 to rectify the AC source into the power supply to the heater of the present invention. The source circuit is comprised of a filter (not illustrated) connected in series with the rectifier 211 to deliver the power form the source circuit 210 to the substrate 100 via the signal touch switch 220. The heating circuit in the substrate 100 is connected to the signal amplification circuit 250, the temperature setup circuit 260 and the corresponding input end of the control circuit 240 and the power from the source circuit 210 is supplied to another input end of the control circuit 240 through the level detection circuit 230 while the output end of the control circuit 240 is connected through the touch end of the signal touch switch 220. As illustrated, the heating circuit in the substrate 100 relates to a heating resistance 101 connected in series with a temperature sensing resistance 102 to a ground potential to conduct through the signal amplification circuit 250 at where between the heating resistance 101 and the temperature sensing resistance 102. Meanwhile, the heating resistance is connected to another end of the temperature sensing resistance where leading to the signal touch switch 220. Accordingly, rectified source, the signal touch switch 220, the heating resistance 101 and the temperature sensing resistance 102 constitute a series loop.

Whereas the paste of the heating resistance gives a low TCR (≦100 PPM), the temperature change to the loop amperage is not significant. Though the TCR of the temperature sensing resistance 102 is as high as 1000 PPM, it resistance is too small (in terms of testing conditions, the heating resistance 101 is of 200 ohm; and the temperature sensing resistance 102, 0.20 ohm) to affect the amperage. In general, the change of the resistance is small for the heating resistance 101 connected in series with the temperature sensing resistance 102 during the fluctuation of temperature. Should a value of the voltage level in each cycle of the since wave be defined as a detection point, the detection point may be deemed as a cyclic constant voltage point (detection point setup circuit). The amperage of the voltage point is fixed (a point referred as VL) without being affected by temperature fluctuation. The product of VL amperage multiplied by the resistance of the temperature sensing resistance 102 relates to the signal transmitted to the signal amplification circuit 250 (VRS). Since the amperage of VL is fixed, VRS changes depending on temperature fluctuation. That is, the value of the temperature sensing resistance rises (drops) as the temperature does, and VRS also increases (decreases) in proportion.

VRS signal is amplified by the signal amplification circuit 205 to improve its judgment capability. Comparing the level at VL with VRS by changing the reference DC voltage level from a comparator, when the temperature is higher than the preset value, the control circuit 240 at the current time point will receive a signal, HI. When the temperature is below the present value, the controller 240 will receive a signal LO inverse to H1. Depending on the input signal to be H1 or L0 detected at VL by the controller circuit 240, a signal is outputted to control the signal touch switch 220. If the signal L0 is detected, the touch switch 220 maintains the heating resistance conducted for it to keep on heating for higher temperature. On the other hand, when the signal L1 is detected, the switch 220 is open to interrupt the conduction of the heating resistance for stopping further temperature rise to achieve the purpose of thermostat control results.

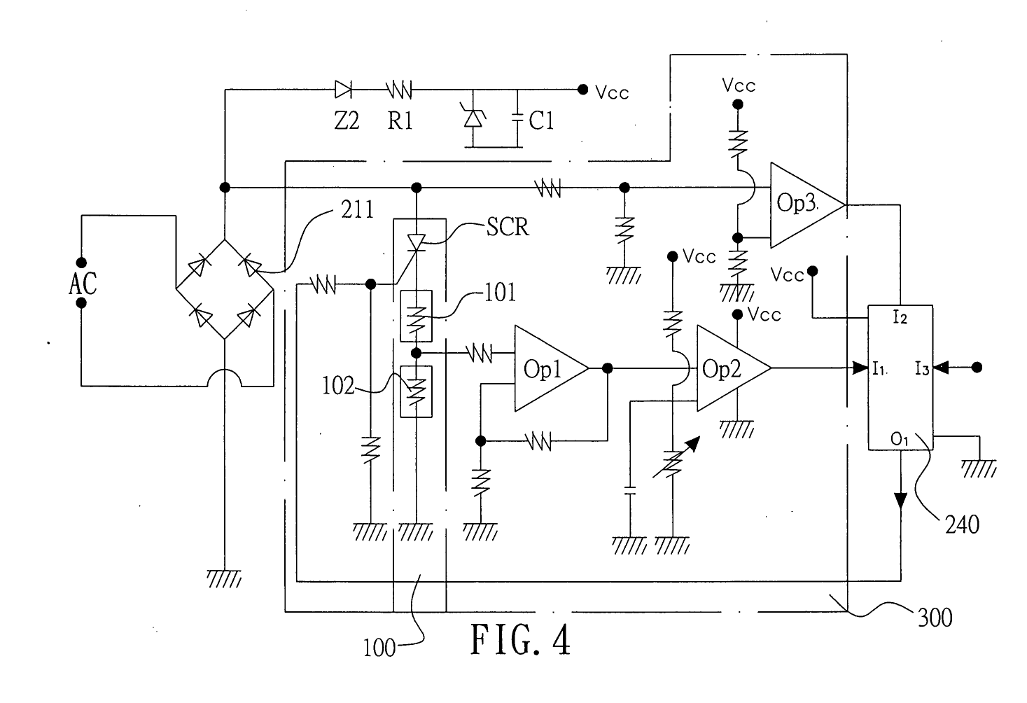

Given the matured technology of A TO D and D TO A provided by SoC, the signal amplification circuit 250, the temperature setup circuit 260 and the level detection circuit 230 can be integrated into a single IC 300 (within the frame marked 300 in FIG. 4 for another preferred embodiment) to simplify the circuit. A comparator (Op2 as marked) for temperature setup is separately inputted to a changed DC voltage level for comparison with the amplified VRS while a silicon-controlled rectifier (SCR) is used to conduct the touch switch 220. The circuit 240 detects the voltage (that enters into I1 of the circuit 240) at the time point (as told by I2 end of the circuit 240) of the circuit 240 at VL, and then an output end O1 of the circuit 240 controls the SCR to drive conduction of controlled heating. The output end O1 of the circuit 240 is programmed to have a minimal power for each cycle to be conducted for VRS detection, and further to control the conduction of the SCR depending on the status of the voltage I1 for achieving the purpose of thermostat protection or control. An I3 end of the circuit 240 is provided to work with the signal fed back by a temperature sensing circuit on the object to be heated. When I3=H1/L0, it indicates that the temperature of the object to be heated has or has not reached the temperature as desire for the I3 to jointly control the SCR for the control of self-protection when the heater reaches its upper limit of preset temperature and for the control of keeping the object to be heated at a constant temperatures.

The present invention of a heater with self-temperature control protection provides greater instantaneous energy and smaller heating area than the prior art does. The present invention is safe to users and free of any dissolution of metal into solution by providing self-protection at a specific temperature without the installation of any metal heating tubes for thermal transfer.

It will be understood that each of the elements described above, or two or more together may also find a useful application in other types of methods differing from the type described above.

While certain novel features of this invention have been shown and described and are pointed out in the annexed claim, it is not intended to be limited to the details above, since it will be understood that various omissions, modifications, substitutions and changes in the forms and details of the device illustrated and in its operation can be made by those skilled in the art without departing in any way from the spirit of the present invention.

I claim:

1. A heater with self-protection of temperature control includes a rectification circuit to supply DC power; a thick film metalized substrate provided thereon a heating resistance and a temperature sensing resistance; a signal touch switch operating either electronically or mechanically to constitute a series circuit with the rectification circuit, the heating resistance and the temperature sensing resistance for controlling the power supply to the heating resistance and the temperature resistance; a signal amplification circuit to amplify signal of drop on the temperature sensing resistance; a temperature set up circuit to set up the temperature, a control circuit to detect and command the operation of the signal switch, and a level detection circuit to detect the time point for the control circuit with the rectification circuit, the switch, the heating resistance and the temperature sensing resistance all connected in series.

2. The heater with self-protection of temperature control of claim 1, wherein, one end of the touch switch is connected to the source and the other end to the heating resistance, and the signal is further connected from the heating resistance to another end of the signal touch switch and further to the temperature sensing circuit in the layout of the signal touch switch, the heating resistance, and the temperature sensing resistance.

3. The heater with self-protection of temperature control of claim 1, wherein, one end of the heating resistance is connected to the source and another end to the signal touch switch, and the signal is connected from the signal touch switch to another end of the heating resistance and further to the temperature sensing resistance in another layout of the signal touch switch, the heating resistance, and the temperature sensing resistance.

4. The heater with self-protection of temperature control of claim 1, wherein, once end of the heating resistance is connected to the source and the other end to the temperature sensing resistance, and the signal is connected from the temperature sensing resistance to the other end of the heating resistance and further to the signal touch switch.

5. The heater with self-protection of temperature control of claim 1, wherein, the amplification circuit, the temperature setup circuit and the level detection circuit are integrated into a single IC.
